(19) United States
(12) Patent Application Publication
(10) Pub. No.: US 2007/0222327 A1
(43) Pub. Date: Sep. 27, 2007

(54) Rear cover of motor

(75) Inventors: Ke-Hsien Li, Taichung City (TW); Meng-Chiu Yu, Taichung (TW)

Correspondence Address: BROWDY AND NEIMARK, P.L.L.C.;624 NINTH STREET, NW, SUITE 300, WASHINGTON, DC, 20001-5303, US

(73) Assignee: TAIWAN LONG HAWN ENTERPRISE CO, Taichung City (TW)

(21) Appl. No.: 11/409,035

(22) Filed: Apr. 24, 2006

(30) Foreign Application Priority Data
Mar. 21, 2006 (TW) 95204675

(51) Int. Cl. H02K 5/16; H01R 39/38

(52) U.S. Cl. 310/239; 310/90

(57) ABSTRACT

A rear cover of a motor includes a main member and two lateral covers. The main member has a first receiving portion with a first room, a second receiving portion with a second room, a third receiving portion with an axle bore. The first receiving portion has two first carbon brush slots, in each of which a first carbon brush is provided. The third receiving portion has a second carbon brush slot, in which a second carbon brush is provided. The lateral covers are connected to the main member to close outer ends of the first carbon brush slots.

### BACKGROUND OF THE INVENTION

1. Field of the Invention

The present invention relates generally to a motor, and more particularly to a rear cover of a motor.

2. Description of the Related Art

When a motor is running, an axle voltage is formed on the spindle, the cover and base, and an axle current flowing between the rotor and base of the bearing will burn the bearing off. It makes the motor with a shorter life.

The solutions to fix above problem include providing an insulator between the bearing and the cover and providing the ground connection on the rotor. The first solution has to change the total design of the motor so that it has a higher cost. It also faces the problem of material aging of the insulator because of the high temperature when the motor is running, so that the motor manufacturers usually do not use this solution. The second solution has an easier technique and lower cost so that it is taken by the manufacturers.

The common solution is providing a metal plate or a carbon brush on the rotor and ground connection of the metal plate or the carbon brush. It always causes heat or spark on the metal plate and the rotor because of friction, so that the metal plate is not the best solution to remove the axle current. It is not easier to cause heat and spark between the carbon brush and the rotor, but the carbon brush increases the size of the motor that is a problem to be fixed.

### SUMMARY OF THE INVENTION

The primary objective of the present invention is to provide a rear cover of a motor, which can remove the axle current of the motor.

According to the objective of the present invention, a rear cover of a motor comprises a main member and two lateral covers. The main member has a first receiving portion, in which a first room receiving a conductive ring of a rotor is provided, a second receiving portion, in which a second room communicated with the first room and receiving a shaft of the rotor is provided, a third receiving portion with an axle bore communicated with the second room to pass through the shaft therethrough. The first receiving portion has two first carbon brush slots at opposite sides thereof communicated outside of the main member and the first room respectively, in each of which a first carbon brush is provided to touch the conductive ring. The third receiving portion has a second carbon brush slot communicated the axle bore and outside of the main member, in which a second carbon brush is provided to touch the shaft. The lateral covers are connected to the main member to close outer ends of the first carbon brush slots.

### BRIEF DESCRIPTION OF THE DRAWINGS

FIG. 1 is an exploded view of a preferred embodiment of the present invention; and

FIG. 2 is a sectional view of the preferred embodiment of the present invention.

### DETAILED DESCRIPTION OF THE INVENTION

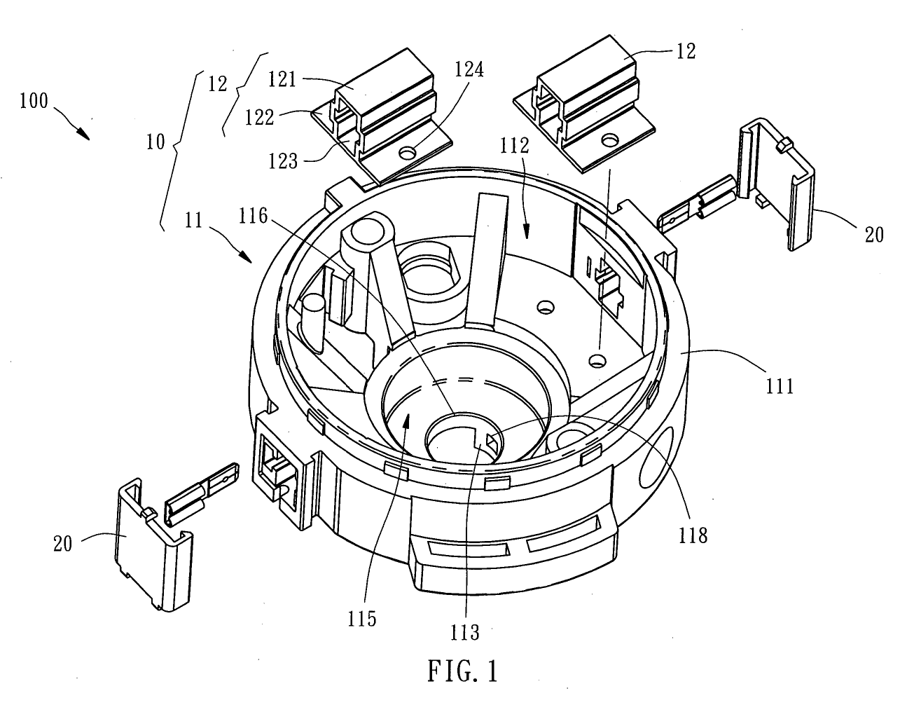

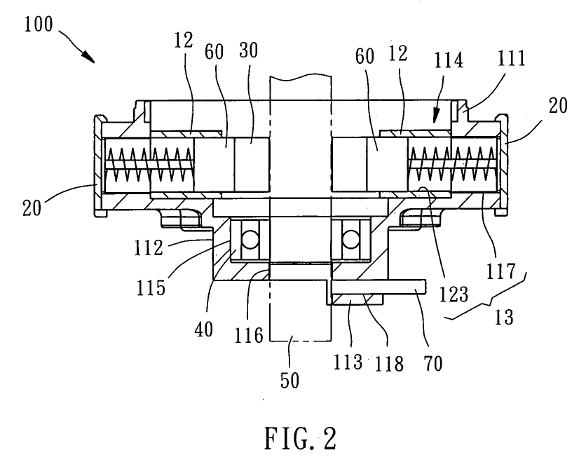

As shown in FIG. 1 and FIG. 2, a rear cover 100 of a motor of the preferred embodiment of the present invention comprises a main member 10 and two lateral covers 20.

The main member includes a rear cover member 11 and two carbon brush bases 12.

The rear cover member 11 is an annular frame made of plastic or other insulators, which includes a first receiving portion 111, a second receiving portion 112 and a third receiving portion 113. The second receiving portion 112 is smaller than the first receiving portion 111 and is communicated with the first receiving portion 111. The third receiving portion 113 is communicated with the second receiving portion 112. The first receiving portion 111 has a first room 114 to receive a conductive copper ring 30 of a rotor therein (shown in FIG. 2). The second receiving portion 112 has a second room 115, which is communicated with the first room 114, to receive a bearing 40 therein. The bearing 40 holds a shaft 50 of the rotor (as shown in FIG. 2). The third receiving portion 113 has an axle bore 116, which is communicated with the second room 115, to pass the shaft 50 of the rotor therethrough. The first receiving portion 111 has two carbon brush bores 117 on opposite sides, which are communicated with the first room 114 and outside of the rear cover member 11. The third receiving portion 113 has a second carbon brush slot 118 communicated the axle bore 116 and outside of the rear cover member 11.

The carbon brush bases 12 are made of heat-resisting metal, each of which has a holding portion 121 and a connection portion 122 on a bottom of the holding portion 121. The holding portion 121 has a carbon brush through hole 123. The connection portion 122 is wider than the holding portion 121 with two bores 124 at opposite sides of the holding portion 121 thereon. The carbon brush bases 12 are fixed in the first receiving portion 111 of the rear cover member 11 by two rivets through the bores 124 and fixed to the rear cover member 11. The brush through holes 123 of the carbon brush bases 12 are aligned with the carbon brush bores 117 of the rear cover member 11 respectively to form a second carbon brush slot 13 to receive a first carbon brush 60 between the holding portion 121 and first receiving portion 111.

The lateral covers 20, which are made of plastic or other insulators, are connected to the rear cover member 11 to close the carbon brush bores 117 respectively.

Above are the elements of the rear cover 100 of the preferred embodiment of the present invention, and the following will describe the operation and characters thereof.

First, a second carbon brush 70, which may be a conductive graphite pole, is inserted into the rear cover member 11 via the second carbon brush slot 118 of the third receiving portion 113. In operation, the shaft of the rotor is received in the axle bore 116, and each of the first carbon brushes 60 touch the conductive copper ring 30 of the rotor to conduct the electricity to the coils of the rotor. The second carbon brush touches the shaft 50 to conduct the axle current out of the motor. As a result, the present invention uses less space (only provides the second carbon brush slot on the third receiving portion) to conduct the axle current out.

In addition, the embodiment of the present invention provides the carbon brush bases fixed on the rear cover member. In fact, the carbon brush bases and the rear cover member may be made in a single unit (it may be made of plastic or metal).

What is claimed is:

1. A rear cover of a motor, comprising:
a main member having a first receiving portion, in which a first room is provided to receive a conductive ring of a rotor therein, a second receiving portion, in which a second room is provided to be communicated with the first room and to receive a shaft of the rotor, and a third receiving portion with an axle bore communicated with the second room to pass the shaft therethrough; the first receiving portion having two first carbon brush slots at opposite sides thereof communicated with outside of the main member and the first room respectively, in each of which a first carbon brush is received to touch the conductive ring; the third receiving portion having a second carbon brush slot communicated with the axle bore and outside of the main member, in which a second carbon brush is provided to touch the shaft; and
two lateral covers connected to the main member to close outer ends of the first carbon brush slots.

2. The rear cover as defined in claim 1, wherein the main member includes a rear cover member, on which the first, second and third rooms are provided, and two carbon brush bases provided in the first receiving portion, each of which has two carbon brush through holes communicated with two carbon brush bores of the first receiving portion to form the first carbon brush slots.

3. The rear cover as defined in claim 2, wherein the main member is made of an insulator and the carbon brush bases are made of a conductor.

4. The rear cover as defined in claim 1, wherein the main member is a single unit with a rear cover member, on which the first, second and third rooms are provided, and two carbon brush bases provided in the first receiving portion, each of which has two carbon brush through holes communicated with two carbon brush bores of the first receiving portion to form the first carbon brush slots.

5. The rear cover as defined in claim 4, wherein the main member is made of an insulator.
